(19) United States
(12) Patent Application Publication
(10) Pub. No.: US 2013/0239543 A1
(43) Pub. Date: Sep. 19, 2013

(54) GAS TURBINE ENGINE CONTROL SYSTEM WITH GAS MONITOR

(71) Applicant: Keith Herbert Bridge, La Mesa, CA (US)

(72) Inventor: Keith Herbert Bridge, La Mesa, CA (US)

(73) Assignee: Solar Turbine Incorporated

(21) Appl. No.: 13/422,625

(22) Filed: Mar. 16, 2012

(51) Int. Cl. F02C 3/20

(52) U.S. Cl. 60/39.463

(57) ABSTRACT

A gas turbine engine configured to operate using a liquid fuel and a gaseous fuel may include a combustor system fluidly coupled to a compressor system and a turbine system. The gas turbine engine may also include a control system configured to selectively direct the gaseous fuel and the liquid fuel to the combustor system based on a concentration of a constituent in the gaseous fuel.

### TECHNICAL FIELD

The present disclosure relates generally to a gas turbine engine control system with a gas monitor, and more particularly to using one or more gas monitors to control the operation of a gas turbine engine.

### BACKGROUND

In a typical gas turbine engine, fuel is combusted in a combustion chamber (called combustor) to produce high pressure combustion gases. These high pressure gases are then used to spin the rotors of a turbine to produce power. Various types of fuel, such as natural gas or a diesel fuel, may be combusted in a gas turbine engine to produce power. Typically, a fuel that is readily available at a location may be used as fuel in gas turbine engines installed at that location. In some cases, however, the readily available fuel supply at a location may include constituents that detrimentally affect the engine. For instance, turbine components (such as the turbine blades) of a gas turbine engine that operate on natural gas may be subject to hot corrosion damage as a result of hydrogen sulfide that may be naturally present in natural gas. One method of protecting the engine from these harmful fuel supply constituents is to place limits on the maximum amount of these constituents that may be present in the fuel. Other techniques to reduce such detrimental effects have also been published. For instance, a technical publication, “Protecting Gas Turbine Components,” by Janis L. Cocking et al., Platinum Metals Rev., 29 (1), pp. 17-19 describes a platinum based coating that may be applied to turbine blades to increase their resistance to hot corrosion damage.

Summary

In one aspect, a gas turbine engine that operates on natural gas is disclosed. The supply of natural gas to the gas turbine engine may be a blend from several sources. Even when the H₂S level in the natural gas supply is within the operating limits, conditions may occur when there is an “upset” in the gas supply that causes the H₂S to go higher than the allowable limit. When such an upset condition is detected, the gas turbine engine is switched to operate on a liquid fuel. Once the gas supply becomes stable again with the H₂S returning to a level within the operating limits, the engine may be changed back to operating on the gas fuel.

In one aspect, a gas turbine engine configured to operate using a liquid fuel and a gaseous fuel is disclosed. The gas turbine engine may include a combustor system fluidly coupled to a compressor system and a turbine system. The gas turbine engine may also include a control system configured to selectively direct the gaseous fuel and the liquid fuel to the combustor system based on a concentration of a constituent in the gaseous fuel.

In another aspect, a method of controlling a gas turbine engine configured to operate using a liquid fuel and a gaseous fuel is disclosed. The method may include monitoring a concentration of a constituent in a gaseous fuel supply to the gas turbine engine. The method may also include selectively providing the gaseous fuel or the liquid fuel to the gas turbine engine based on the concentration of the constituent in the gaseous fuel supply.

In yet another aspect, a gas turbine engine is disclosed. The gas turbine engine may include a combustor system configured to combust natural gas and a second fuel therein. The gas turbine engine may also include a control system configured to continuously monitor a concentration of hydrogen sulfide in the natural gas, and switch a fuel supply to the combustor system from natural gas to the second fuel when the concentration of hydrogen sulfide in the natural gas is greater than a threshold value.

### BRIEF DESCRIPTION OF THE DRAWINGS

FIG. 1 is a cutaway-view illustration of an exemplary disclosed gas turbine engine;

FIG. 2 is a schematic of an exemplary control system of the gas turbine engine of FIG. 1; and

FIG. 3 is a flow chart that illustrates an exemplary method of controlling the fuel supply to the gas turbine engine of FIG. 1.

### DETAILED DESCRIPTION

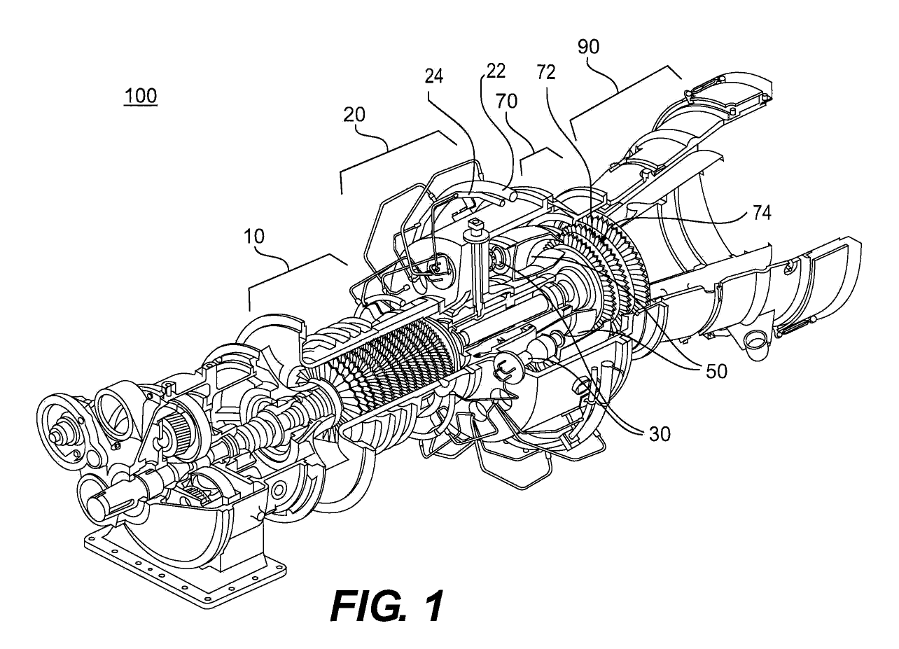

FIG. 1 illustrates an exemplary gas turbine engine 100. Gas turbine engine 100 may have, among other systems, a compressor system 10, a combustor system 20, a turbine system 70, and an exhaust system 90. In general, compressor system 10 compresses air to a high pressure and directs the compressed air to combustor system 20. A gaseous fuel or a liquid fuel is directed to the combustor system 20 through a gaseous fuel pipe 22 or a liquid fuel pipe 24, respectively. One of more of these fuels are mixed with the compressed air in fuel injectors 30 and combusted in a combustor 50 of the combustor system 20. Since both a liquid fuel and a gaseous fuel may be selectively directed to combustor 50 through fuel injectors 30, gas turbine engine 100 is commonly called a dual fuel gas turbine engine, and fuel injectors 30 are commonly called dual fuel injectors. Combustion of the fuel in the combustor 50 produces combustion gases at a high pressure, temperature, and velocity. These combustion gases are directed to the turbine system 70. In the turbine system 70, the high pressure combustion gases expand against turbine blades 72 to rotate turbine wheels or rotors 74 and generate power. The spent combustion gases are then exhausted to the atmosphere through exhaust section 90.

Various types of gaseous fuel and liquid fuel may be directed into combustor 50 through fuel injectors 30. The gaseous fuel may include, for example, natural gas, landfill gas, bio-gas, syngas, etc. The liquid fuels directed to combustor system 20 may include diesel, kerosene, gasoline, or any other type of liquid fuel. In some applications, the gas turbine engine 100 may be operated primarily using a fuel that is cheaply available at the location where the gas turbine engine 100 is operating. For example, in an oil field with an abundant supply of natural gas, the gas turbine engine 100 may operate primarily using natural gas. In such applications, liquid fuel may be reserved for engine operating conditions where a liquid fuel may be more desirable. For instance, a liquid fuel may be directed to gas turbine engine 100 during startup and when combustion instabilities are detected in the combustor 50. After the gas turbine engine 100 reaches a stable operating condition, the liquid fuel supply to the fuel injectors 30 may be turned off, and the gaseous fuel supply turned on. Operating the gas turbine engine 100 using a fuel that is widely available at a location reduces cost and increases operating efficiency.

As the high pressure combustion gases from the combustor 50 expand against the turbine blades 72, constituents in the combustion gases may chemically react with the material of the turbine blades 72. The high temperature of the combustion gases may stimulate the chemical reaction between the combustion gases and the turbine blades 72. Over time, these chemical reactions may damage the turbine blades 72. The harmful combustion gas constituents (that may chemically attack the turbine blades 72) may be present in the fuel and/or air supplied to the combustor 50. One such harmful constituent is hydrogen sulfide (H₂S). Hydrogen sulfide, a flammable gas produced by bacterial breakdown of organic material, may be naturally present in fuels such as natural gas. In a gas turbine engine 100 that operates on natural gas, the hydrogen sulfide present in the fuel may chemically attack the turbine blades 72 through a process known as hot corrosion. During hot corrosion, the hydrogen sulfide and moisture in the combustion gas reacts to form sulfuric acid that corrodes the turbine blades 72. In some applications, the turbine blades 72 may be coated with one or materials to reduce the effects of hot corrosion. However, due to the high temperatures that the turbine blades 72 are exposed to, over time the hydrogen sulfide (or another chemical constituent) in the combustion gases may react with, and detrimentally affect, the structural reliability of the turbine blades 72 and/or other components of gas turbine engine 100.

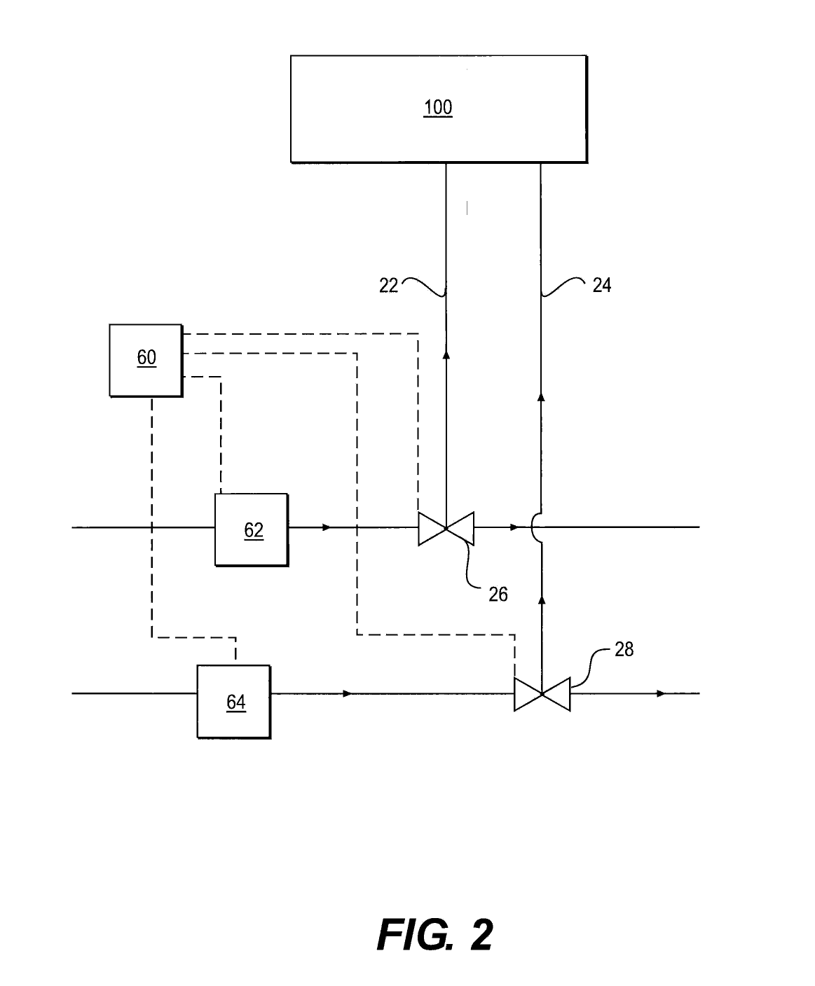

FIG. 2 is a schematic illustration of a control system 60 of gas turbine engine 100. Control system 60 may control the operation of the gas turbine engine 100. For instance, based on power requirements, control system 60 may control the amount of fuel directed to the gas turbine engine 100 through gaseous fuel pipe 22 or liquid fuel pipe 24 to produce the required power in a stable manner. Control system may include a microprocessor, storage memory, and/or other electronic components (not shown) that operate to control the operation of gas turbine engine 100. In addition to functions normally performed by turbine engine control systems known in the art, control system 60 may also control the type and quantity of fuel supplied to the gas turbine engine 100 based on operating parameters. Gaseous fuel pipe 22 and/or liquid fuel pipe 24 may be fluidly coupled to sensors and measurement devices configured to measure parameters related to the flow of fuel therethrough. These sensors may include, among others, a hydrogen sulfide monitor 62 that measures the concentration of hydrogen sulfide in the gaseous fuel directed to gas turbine engine 100 through gaseous fuel pipe 22. In some embodiments, liquid fuel pipe 24 may also be fluidly coupled to a concentration monitor 64 (such as, for example, a hydrogen sulfide monitor) that is adapted to measure a concentration of a constituent of the liquid fuel directed to gas turbine engine 100.

Hydrogen sulfide monitor 62 may include any type of monitor that is configured to continuously measure a concentration of hydrogen sulfide in the gaseous fuel directed to the gas turbine engine 100. For example, hydrogen sulfide monitor 62 may include a thin film metal oxide semiconductor (TFMOS) sensor that outputs a signal indicative of the concentration of hydrogen sulfide in the gaseous fuel stream. Although the hydrogen sulfide monitor 62 is described as measuring the concentration of hydrogen sulfide continuously, it is contemplated that a sensor that measures a parameter indicative of the concentration of hydrogen sulfide in the gaseous fuel stream at discrete time intervals (such as, for example, an electronic sensor that takes discrete measurements at a frequency of greater than or equal to about one measurement per minute) may be used as hydrogen sulfide monitor 62.

Control system 60 is electrically coupled to hydrogen sulfide monitor 62 to detect the concentration of hydrogen sulfide in the gaseous fuel directed to gas turbine engine 100. In embodiments that include the concentration monitor 64 and other sensors, the control system 60 may also be electrically coupled with the concentration monitor 64 and the other sensors. The gaseous fuel pipe 22 and liquid fuel pipe 24 may also include control valves 26, 28 and other flow control devices (not shown) that may be manipulated by control system 60 to control the amount of fuel flowing through these conduits. Based on operating parameters of gas turbine engine 100 (such as, for example, engine load, temperature, etc.) and/or a concentration of a constituent in a fuel directed to gas turbine engine 100, control system 60 may send signals to control valve 26 and/or control valve 28 to vary (increase, decrease, stop, or start) the fuel flow through the gaseous fuel pipe 22 and/or the liquid fuel pipe 24. For example, if the hydrogen sulfide monitor 62 detects that the concentration of hydrogen sulfide in the gaseous fuel (directed to gas turbine engine 100) is greater than or equal to a predetermined threshold value, the control system 60 may send signals to control valve 26 to stop (or decrease) the flow of gaseous fuel through gaseous fuel pipe 22 and start (or increase) the flow of liquid fuel flowing to the gas turbine engine 100 through liquid fuel pipe 24. The control system 60 may continuously monitor the concentration of hydrogen sulfide in the gaseous fuel flow, and switch the fuel supply (to gas turbine engine 100) back to gaseous fuel when the concentration of hydrogen sulfide decreases below the threshold value. In some embodiments, the fuel supply to the gas turbine engine 100 may be switched (from liquid to gaseous fuel, and from gaseous to liquid fuel) only if the concentration of hydrogen sulfide is above or below the threshold value for a predetermined time.

Although switching the fuel supply to the turbine engine 100 from gaseous to liquid fuel when the concentration of hydrogen sulfide in the gaseous fuel is greater than or equal to a threshold value is described herein, this is only exemplary. In general, the control system 60 may vary the amount and type of fuel directed to the gas turbine engine 100 based on a measured concentration of any constituent in the fuel (liquid or gaseous) directed to gas turbine engine 100. The operation of control system 60 of the gas turbine engine 100 will be described in the next section.

Industrial Applicability

The disclosed gas turbine engine control system may be applicable to any gas turbine engine configured to operate using two or more types of fuel. The disclosed control system may be applicable to a gas turbine engine regardless of the type of fuels used, and may reduce corrosion or other negative effects on components that occur as a result of a constituent of the fuel supplied to the gas turbine engine. The operation of gas turbine engine 100 will now be explained.

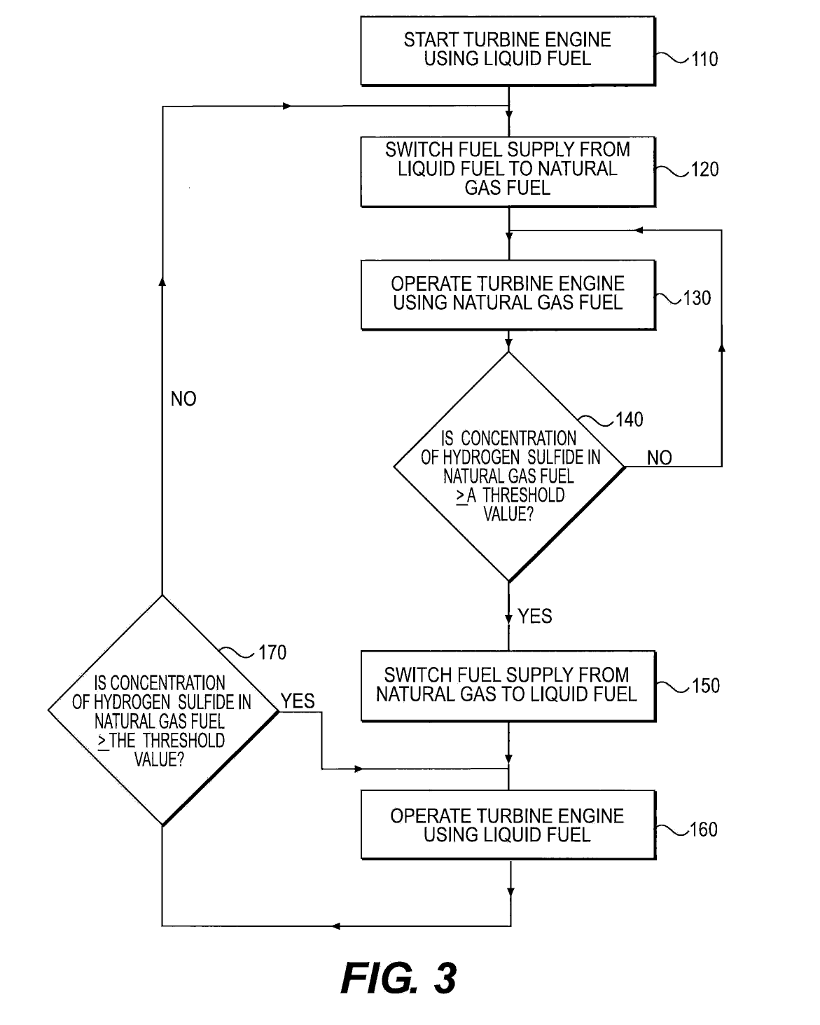

FIG. 3 is a flow chart illustrating an exemplary operation of the gas turbine engine 100 using natural gas and a liquid fuel as fuel. The gas turbine engine 100 is started using the liquid fuel (step 110). After the power output (or speed, or some other parameter) of the gas turbine engine 100 exceeds a desired valve, control system 60 may activate control valves 26, 28 to switch the fuel supply to the gas turbine engine 100 from the liquid fuel to natural gas fuel (step 120). That is, the control system 60 may decrease, and finally stop, the liquid fuel supply to the gas turbine engine 100, while the natural gas supply to the gas turbine engine 100 is correspondingly started and increased. The control system 60 may then operate the gas turbine engine 100 using natural gas fuel (step 130). Operating the gas turbine engine 100 using the locally available natural gas fuel may increase the cost efficiency of the gas turbine engine 100. As the natural gas fuel is directed to the gas turbine engine 100, the concentration of hydrogen sulfide in the natural gas is continuously monitored by control system 60 using hydrogen sulfide monitor 62 (step 140). If the concentration of hydrogen sulfide is less than a threshold value, the control system 60 continues the natural gas supply to the gas turbine engine 100. If however, the concentration of hydrogen sulfide is greater than or equal to the threshold valve, the control system 60 switches the fuel supply to the gas turbine engine 100 from natural gas fuel to liquid fuel (step 150). That is, the control system 60 decreases, and finally stops, the natural gas supply to the gas turbine engine 100, while the liquid fuel supply to the gas turbine engine 100 is correspondingly started and increased. The gas turbine engine 100 is then operated using liquid fuel (step 160). Even when the gas turbine engine 100 is operating on liquid fuel, the control system 60 continuously monitors the concentration of hydrogen sulfide in the natural gas directed to the gas turbine engine 100 (step 170). If the concentration of hydrogen sulfide in the natural gas supply stays equal to or greater than the threshold value, the control system 60 continues the operation of the gas turbine engine 100 using the liquid fuel (step 160). If however, the concentration of hydrogen sulfide decreases below the threshold value, the fuel supply to the gas turbine engine 100 is switched from liquid fuel to natural gas (step 120). Thus, the control system 60 operates the gas turbine engine 100 using natural gas as the fuel when the concentration of hydrogen sulfide in the natural gas is below a threshold value, and using a liquid fuel when the concentration of hydrogen sulfide in the natural gas is greater than or equal to the threshold value.

In some embodiments, the control system 60 switches the fuel supply to the gas turbine engine 100 from natural gas fuel to liquid fuel (step 150) only if the hydrogen sulfide concentration in the natural gas is greater than or equal to the threshold value for a threshold time interval in step 140. Similarly in some embodiments, the control system 60 switches the fuel supply from liquid fuel to natural gas fuel (step 120) only if the hydrogen sulfide concentration in natural gas stays below the threshold value for a threshold time interval in step 170. The threshold value of concentration and the threshold time intervals for switching between the fuel types may be preselected or may be automatically selected by the control system 60 based on the characteristics of fuel supply at a particular location. For instance, it may be known that a concentration of hydrogen sulfide in natural gas fuel above a certain percentage value may lead to unacceptable levels of hot corrosion. Therefore, the threshold value may be preselected to be at that percentage value. And, based on historical trends in the concentration of hydrogen sulfide in the natural gas fuel supply at the location, the control system 60 may select the threshold time intervals to switch from natural gas fuel to liquid fuel and from liquid fuel to natural gas.

The supply of natural gas at a location may be a blend from several sources. Even when the H₂S level in the gas supply at the location is within the operating limits, conditions can occur when there is an “upset” in the supply that causes the H₂5 to go higher than the allowable limit. When this is detected the operation is changed over to run on liquid fuel. Once the gas supply becomes stable again with the H₂S returning to a level within the operating limits, the engine may be changed back to operating on the gas fuel. Switching the fuel supply directed to the gas turbine engine 100 when the concentration of a harmful fuel constituent reaches an undesirable level helps prolong the life of the gas turbine engine 100.

It will be apparent to those skilled in the art that various modifications and variations can be made to the disclosed gas turbine engine control system. Other embodiments will be apparent to those skilled in the art from consideration of the specification and practice of the disclosed gas turbine engine control system. It is intended that the specification and examples be considered as exemplary only, with a true scope being indicated by the following claims and their equivalents.

What is claimed is:

1. A gas turbine engine configured to operate using a liquid fuel and a gaseous fuel, comprising:
a combustor system fluidly coupled to a compressor system and a turbine system; and
a control system configured to selectively direct the gaseous fuel and the liquid fuel to the combustor system based on a concentration of a constituent in the gaseous fuel.

2. The gas turbine engine of claim 1, wherein the control system is configured to direct the gaseous fuel to the combustor system when the constituent concentration is below a threshold value, and direct the liquid fuel to the combustor system when the constituent concentration is greater than the threshold value.

3. The gas turbine engine of claim 2, wherein the control system is configured to direct the liquid fuel to the combustor system when the constituent concentration is greater than the threshold value for a threshold time.

4. The gas turbine engine of claim 1, further including a constituent monitor configured to monitor the concentration of the constituent in the gaseous fuel supply to the combustor system.

5. The gas turbine engine of claim 4, further including a liquid fuel line configured to direct the liquid fuel to the combustor system and a gaseous fuel line configured to direct the gaseous fuel to the combustor system, the constituent monitor being fluidly coupled to the gaseous fuel line.

6. The gas turbine engine of claim 1, further including one or more fuel injectors coupled to the combustor system, the one or more fuel injectors being configured to selectively direct the gaseous fuel and the liquid fuel to the combustor system.

7. The gas turbine engine of claim 1, wherein the gaseous fuel is natural gas and the constituent is hydrogen sulfide.

8. A method of controlling a gas turbine engine configured to operate using a liquid fuel and a gaseous fuel, comprising:
monitoring a concentration of a constituent in a gaseous fuel supply to the gas turbine engine; and
selectively providing the gaseous fuel or the liquid fuel to the gas turbine engine based on the concentration of the constituent in the gaseous fuel supply.

9. The method of claim 8, wherein the selectively providing includes providing the gaseous fuel to the gas turbine engine when the concentration is less than a threshold value, and providing the liquid fuel to the gas turbine engine when the concentration is greater than the threshold value.

10. The method of claim 9, wherein providing the liquid fuel to the gas turbine engine includes providing the liquid fuel when the concentration is greater than the threshold value for a threshold time.

11. The method of claim 8, supplying the gaseous fuel includes supplying natural gas to the gas turbine engine.

12. The method of claim 11, wherein monitoring the concentration includes monitoring the concentration of hydrogen sulfide in the natural gas.

13. The method of claim 12, wherein selectively providing the gaseous fuel or the liquid fuel includes providing natural gas to the gas turbine engine when the concentration of hydrogen sulfide in the natural gas supply is less than a threshold value, and providing the liquid fuel to the gas turbine engine when the concentration of hydrogen sulfide in the natural gas supply is greater than the threshold value.

14. A gas turbine engine, comprising:
a combustor system configured to combust natural gas and a second fuel therein;
a control system configured to continuously monitor a concentration of hydrogen sulfide in the natural gas and switch a fuel supply to the combustor system from natural gas to the second fuel when the concentration of hydrogen sulfide in the natural gas is greater than a threshold value.

15. The gas turbine engine of claim 14, wherein the control system is configured to direct the natural gas to the combustor system when the concentration of hydrogen sulfide in the natural gas is less than the threshold value.

16. The gas turbine engine of claim 15, wherein the control system is configured to switch the fuel supply to the combustor system from natural gas to the second fuel when the concentration of hydrogen sulfide in the natural gas is greater than the threshold value for a threshold time.

17. The gas turbine engine of claim 14, further including a hydrogen sulfide monitor fluidly coupled to a conduit that supplies natural gas to the gas turbine engine.

18. The gas turbine engine of claim 17, wherein the hydrogen sulfide monitor is configured to continuously measure the concentration of hydrogen sulfide in the natural gas.

19. The gas turbine engine of claim 14, further including one or more fuel injectors coupled to the combustor system, the one or more fuel injectors being configured to selectively direct the natural gas and the second fuel to the combustor.

20. The gas turbine engine of claim 14, wherein the second fuel is a liquid fuel.
